(19) United States
(12) Patent Application Publication
(10) Pub. No.: US 2010/0077602 A1
(43) Pub. Date: Apr. 1, 2010

(54) METHOD OF MAKING AN ELECTRICAL HEATER

(76) Inventor: Wolfgang KOLLENBERG, Bruehl (DE)

Correspondence Address: K.F. ROSS P.C., 5683 RIVERDALE AVENUE, SUITE 203 BOX 900, BRONX, NY, 10471-0900, US

(21) Appl. No.: 12/559,608

(22) Filed: Sep. 15, 2009

(30) Foreign Application Priority Data
Sep. 27, 2008 (DE) 202008049215.9

(51) Int. Cl. B23P 17/00

(52) U.S. Cl. 29/611

(57) ABSTRACT

An electrical heater is made by first providing on a surface of a heater support a dielectric inner layer and then projecting by an inkjet-printing method droplets of an emulsion or dispersion of conductive particles in a vehicle or binder onto the dielectric layer to form thereon a continuous film. The binder or vehicle are removed and a protective dielectric outer layer is provided over the film.

### FIELD OF THE INVENTION

The present invention relates to an electrical heater. More particularly this invention concerns an electrical heater for a flow passage of an injection-molding machine.

### BACKGROUND OF THE INVENTION

An electric heater for technical purposes, in particular for heating hot passage systems, hot runners, hot passage nozzles, tools of injection molding machines, has a dielectric layer at least partially covering a surface of the heater or of a heater support, to which an electric resistance element is applied that has electric terminals for connection to an electric power source. The resistance element is in turn covered by a protective layer, in particular a dielectric layer.

DE 10 2006 061 435, DE 10 320 379, DE 44 06 940, U.S. Pat. No. 6,861,101, U.S. Pat. No. 5,766,693, DE 101 60 451, US 2004/0055153, EP 1 672 958 A2 and U.S. Pat. No. 7,361,869 disclose applying a strip conductor by plasma or flame-spraying to a substrate. The disadvantage of this process is that it is very expensive and uses a great deal of energy.

U.S. Pat. No. 7,029,260 describes applying a heat conductor by means of thin-film technique, the heat conductor being applied as thin film in the form of a conductive dye.

U.S. Pat. No. 6,797,925 describes a method for making an electrical heater where the conductive layer is applied by means of a film, thick-layer or screen printing technique. The method described here is also expensive and not suited to cost-effective large-scale production.

Finally, U.S. Pat. No. 4,90,375 describes a surface heater whose the conductive layer is applied by screen printing of pastes and is baked at high temperatures. The heat conductor tracks are Thus applied by a thick-layer paste technique.

### OBJECTS OF THE INVENTION

It is therefore an object of the present invention to provide an improved electrical heater.

Another object is the provision of such an improved electrical heater that overcomes the above-given disadvantages, in particular that can be manufactured particularly easily, cost-effectively and rapidly so that large quantities can be offered at competitive prices.

### SUMMARY OF THE INVENTION

An electrical heater is made by first providing on a surface of a heater support a dielectric inner layer and then projecting by an inkjet-printing method droplets of an emulsion or dispersion of conductive particles in a vehicle or binder onto the dielectric layer to form thereon a continuous film. The binder or vehicle are removed and a protective dielectric outer layer is provided over the film.

In other words, the object of the invention is attained by applying the resistance element by printing. An emulsion or dispersion of electrically conductive particles and a support or binder material is applied dropwise to the inner dielectric layer to form the electric resistance element. According to the invention electrically conductive particles are thus applied locally for example by a printer head of an inkjet printer, to form the electric resistance element. Different outputs can be provided for the electric resistance element by corresponding material selection and corresponding layer thickness. Applying corresponding dispersions by printing is extremely easy and very quick and thus cost-effective to perform, resulting in convenient large-scale application for manufacturing large piece counts.

Preferably the layer created by applying the emulsion or dispersion, in particular the resulting layer of electrically conductive particles, has a layer thickness adequate for electric resistance heating.

Furthermore the electrically conductive particles comprise a metal powder, preferably copper or a copper alloy. The metal powder can be provided in the form of a dispersion, for example, to form the corresponding heater as per the invention.

According to a further feature of the invention the conductive particles are a metallic oxide, a carbide, a nitride, or a silicide, or mixtures thereof. Alternately they are molybdenum disilicide, silicon nitride, a mixture of silver and aluminum oxide, or a mixture of copper and silicon carbide.

At the same time that the dispersion or emulsion is applied by means of a device which has a print head similar to that of an inkjet printer and the dispersion or emulsion is applied dropwise thereby.

The emulsion or dispersion applied in the form of the resistance element is dried and sintered after application such that the electrically conductive particles are combined and in particular are fused into a continuous electric resistance element. The individual electrically conductive particles are combined or fused into a continuous electric resistance element by the drying and sintering procedure such that corresponding resistance is provided as heater.

The dielectric layer is a ceramic, in particular aluminum oxide. The protective layer can also be a ceramic, in particular aluminum oxide.

A particular feature here is that the entire surface of the heater or of the heater support is coated with a dielectric layer of ceramic material, for example by dip coating or by a flame-spray process.

The entire surface of the heater can easily be coated with a dielectric layer. Selective coating of individual surfaces is not required.

The protective layer is applied and fixed by dip coating and subsequent tempering. Here partial coating of the electric heater takes place only in the region of the resistance conductor with the protective layer which is applied for example by dip coating and is subsequently fixed by tempering.

In a manner known per se the heater or the heater support comprises metal. Similarly the heater or the heater support is a tubular heater or a cylindrical heating cartridge or sleeve. Here the emulsion or dispersion is applied by drop-on-demand printing.

### BRIEF DESCRIPTION OF THE DRAWING

The above and other objects, features, and advantages will become more readily apparent from the following description, reference being made to the accompanying drawing in which:

FIG. 1 is a largely schematic view of a first step of the inventive method; and

FIGS. 2-6 are similar views of subsequent steps of the inventive method.

### SPECIFIC DESCRIPTION

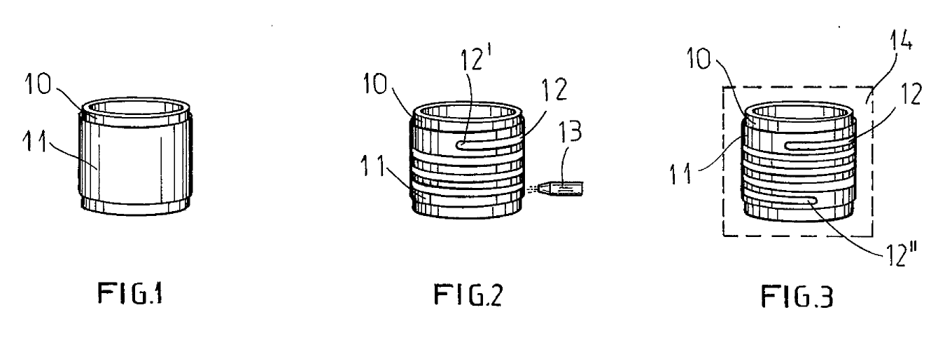

As seen in FIG. 1 a cylindrically tubular support 10, here a metallic (e.g. steel or aluminum) sleeve is first provided on its cylindrical outer surface with a dielectric layer 11, here of aluminum oxide.

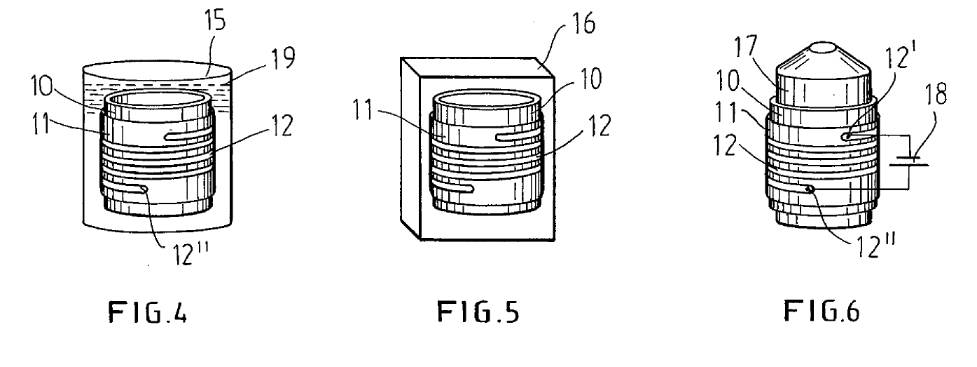

Then as shown in FIG. 2 a continuous helical film 12 comprised of a dispersion or emulsion of copper particles in a binder or vehicle is sprayed by a device 13 on the dielectric layer 12, with the ends 12 and 12′ of the film forming contacts or terminals.

Then as shown in FIG. 14 the workpiece 10, 11, 12, is put in a chamber where the vehicle or binder of the film is removed, typically by heating, leaving behind only the particles. This operation is carried out or ends at high enough temperature to sinter together the particles into a conductive but resistive layer that, when electricity flows through it, generates significant heat.

Thereafter as shown in FIG. 4 the workpiece 10, 11, 12 is dipped in a vessel 15 holding a body 19 of coating liquid. The ends of the tube 10 may be plugged or the tube otherwise masked to prevent the liquid 19 from coating its interior. Only the exterior surfaces over the film 12 need be thoroughly coated.

Subsequently the externally coated workpiece 10, 11, 12 is autoclaved again to harden the coating into a hard protective layer, typically also of aluminum dioxide.

Finally the completed heater is fitted over a nozzle 17 of an injection-molding machine and the contacts 12′ and 12″, which have been exposed through the outer conductive layer, are connected to a power source illustrated schematically at 18.

The invention thus provides a simple method by means of which an electric heater can be provided with electric resistance elements of any shape which can also be easily made in heavy forms or structures, enabling large-scale and cost-effective manufacture

I claim:

1. A method of making an electrical heater, the method comprising the steps of sequentially:
providing on a surface of a heater support a dielectric inner layer;
projecting droplets of an emulsion or dispersion of conductive particles in a vehicle or binder onto the dielectric layer to form thereon a continuous film; and
providing over the droplets on the layer a protective dielectric outer layer.

2. The heater-making method defined in claim 1 wherein the droplets are provided in a thick enough layer that the film forms a resistive-heating element.

3. The heater-making method defined in claim 2 wherein the particles are of metal.

4. The heater-making method defined in claim 3 wherein the metal is copper.

5. The heater-making method defined in claim 2 wherein the droplets of the dispersion or emulsion are applied to the inner dielectric layer by an inkjet-printer head.

6. The heater-making method defined in claim 2, further comprising the step of
drying the film after.

7. The heater-making method defined in claim 6, further comprising the step after drying the film of:
sintering together the particles of the emulsion or dispersion.

8. The heater-making method defined in claim 7 wherein the inner dielectric layer is aluminum oxide.

9. The heater-making method defined in claim 7 wherein the outer dielectric layer is aluminum oxide.

10. The heater-making method defined in claim 2 wherein substantially an entire exposed outer surface of the support, inner dielectric layer, and film are provided with the outer dielectric layer by dipping for flame-spraying.

11. The heater-making method defined in claim 10 wherein the outer dielectric layer is provided by dipping and subsequent tempering.

12. The heater-making method defined in claim 2 wherein the support is of metal.

13. The heater-making method defined in claim 12 wherein the metal support is a tube.

14. The heater-making method defined in claim 1 wherein the droplets are applied by drop-on-demand printing.

15. The heater-making method defined in claim 1 wherein the conductive particles are metal, an oxide, a carbide, a nitride, or a silicide, or mixtures thereof.

16. The heater-making method defined in claim 1 wherein the conductive particles are molybdenum disilicide, silicon nitride, a mixture of silver and aluminum oxide, or a mixture of copper and silicon carbide.
